(19) United States
(12) Patent Application Publication
(10) Pub. No.: US 2013/0248748 A1
(43) Pub. Date: Sep. 26, 2013

(54) Double eccentric butterfly valve

(71) Applicant: Hans D. Baumann, W. Palm Beach, FL (US)

(72) Inventor: Hans D. Baumann, W. Palm Beach, FL (US)

(21) Appl. No.: 13/506,011

(22) Filed: Mar. 21, 2012

(51) Int. Cl. F16K 1/22

(52) U.S. Cl. 251/305

(57) ABSTRACT

A double eccentric butterfly valve having a housing, a shaft, a seat ring, and a vane, wherein the seat ring is radially flexible to conform to the spherical rim of a vane having one of the rim portions extending in width in order to improve the dynamic torque characteristics of the valve; means to prevent expulsion of the shaft from the vane due to hydrostatic forces of fluid passing the valve.

### BACKGROUND OF THE INVENTION

While butterfly valves have been used for many centuries, based primarily on a round disk which is turned by a shaft within a tubular body, more modem versions have only appeared within the past 50 years.

Added features, or improvements, included means to obtain tight shut-off when in the closed position, and ways to reduce dynamic torque created by suction effects on the vane caused by high fluid velocities.

One of the common applications of butterfly valves is in the heating and air-conditioning business, replacing cast iron globe valves with flanged housings and reciprocating valve plugs (the primary throttling element).

Such globe valves are excessively heavy and therefore costly. Another drawback is the installed length of such a valve in a piping system.

Finally, Globe valve actuation requires more mechanical power to lift circular plugs off an orifice against fluid pressure.

This invention overcomes these objections and, in addition, provides important improvements over butterfly valves of prior art. For example, a 4-inch globe valve has a length of 14 inches and a weight of 205 lbs, excluding the actuating device. In contrast, my butterfly valve weighs only 24 lbs and has an installed length of only 2.5 inches, thus offering substantial cost and space savings without compromising performance.

Similar to globe valves, the current invention provides tight shut-off when closed and is able to control fluid flow to less than 2% of the wide-open flow capacity. In addition, it takes less mechanical energy to turn a butterfly vane, resulting in cost savings for the actuating device.

There are prior art devices capable of performing similar functions. However, they do not match the level of sophistication which my invention offers. In order to provide tight shut-off, some devices as in U.S. Pat. No. 4,860,994 employ a spring-loaded, flexible, circular Teflon seal. These seals have to flex into the horizontal direction, in order to conform to the given geometry of the closing vane periphery. This leads to wear and are subject to deformation by high fluid pressures. This invention, on the other hand, employs either a flexible metal ring that can deform only in the radial direction, or, an embedded o-ring seal, which offers an inexpensive way to replace the seal when needed.

In addition, my seal is self-adjusting. It can move radially during assembly, to perfectly match up with the center of the spherical vane rim; thus being immune to machining tolerances.

Other designs, see U.S. Pat. No. 4,489,917 for example, use a rubber-lined housing bore in order to achieve tight contact with the vane, when the latter is squeezed into a closed-position. However, such deformation of the rubber liner creates a substantial amount of radial friction which not only requires extra actuating forces, but also creates hysteresis, very detrimental to automatic control.

This invention, on the other hand employs a right combination of vane eccentricity and the radial dimension of the spherical vane seating periphery, to produce a favorable “Angle of Approach”, which allows a gentle contact with my seals in order to overcome such stickiness.

Other prior art such as U.S. Pat. No. 6,793,197 rely on special geometric contours either on the vane's periphery, or inside the housing bore, in order to obtain a desired mathematical relationship between the degree of vane travel and the percentage of fluid increase. The current invention in contrast relies on the natural distance change between the spherical vane seating surface and the cylindrical housing bore thus obtaining a satisfying fluid increase relationship, while not mathematically correct, nevertheless avoid such complicated machining operations.

In contrast to other prior art devices where the vane is looked onto the stem, my vane is free to slide on a square shaft, thus enabling the vane to self-center onto the seat ring and otherwise avoid the vane's dislocation by thermal expansion differences between shaft and housing.

Finally, since the upper halve of my vane has an area, subjected to fluid pressure, which is larger than that of the lower halve, owing to the eccentric location of the shaft. As a result, there exists a large opening torque when fluid enters the valve from the side of the seal. I have added a lower, semi-circular rim adjacent to the lower sealing edge of my vane to mitigate this dynamic torque effect

Likewise, there is a dynamic torque tending to close the vane, when fluid enters the housing from the side where the shaft is located. Here again, I added a protruding semi-circular ring on the shaft side of the vane's lower periphery. This protrusion provides an impact area for the flowing fluid, again, lowering the total dynamic torque.

These and other benefits and advantages of the invention will be better understood in view of the following description.

### BRIEF DESCRIPTION OF THE DRAWINGS

FIG. 1 shows a central, cross-sectional view of a preferred embodiment of my invention, with the vane shown in the closed position.

FIG. 2 shows an enlarged view of the lower part of the view in FIG. 1, featuring a different seat-sealing arrangement in form of a deformable metal ring.

FIG. 3 shows yet another detail, featuring a different mounting arrangement of a plastic seal ring, also featured in FIG. 1.

FIG. 4 shows the embodiment of FIG. 1 in a cross-sectional view along the lines X-X in FIG. 1.

### DESCRIPTION OF THE INVENTION

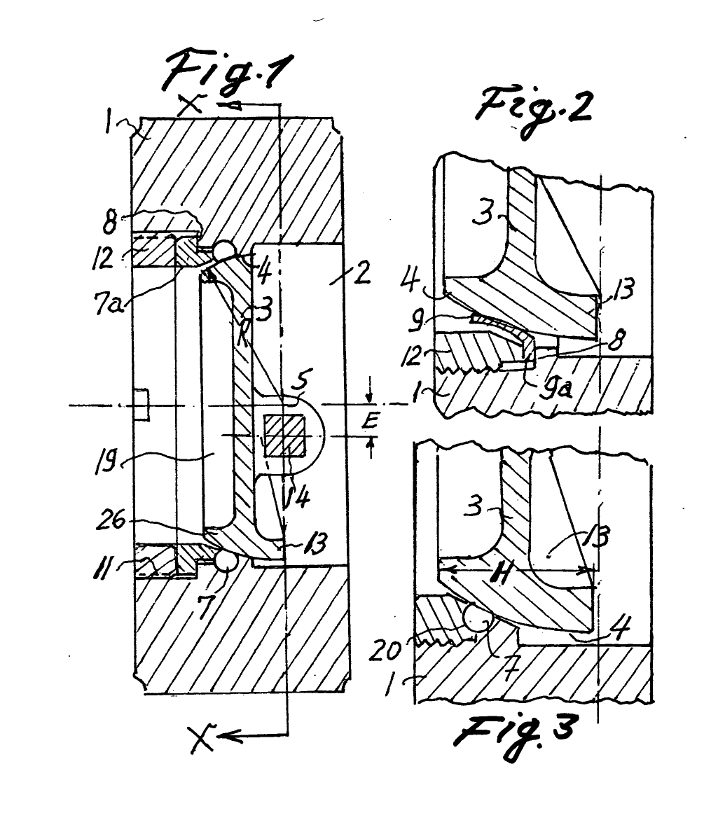

Referring to FIG. 1, the invention comprises a housing 1, having a concentric opening 2 on one end and a threaded opening 11 on the other side. A vane 3, able to be rotated by a square portion 14 of a shaft 6 whose center is off-set from the center of opening 2 by a distance E.

Hub portions 5 serve to connect said shaft to the vane. Vane 3 furthermore has a circular rim 4, along radius R, originating from the center of opening 2. Said rim 4 interacts with an elastic seal 7 partly embedded in a groove in housing 1 and partly supported by a retaining ring 7a which is forced against a step shoulder 8, in housing 1, by a ring shaped nut 12.

Vane 3 furthermore has a circular recess 19, the depth of which is about 15% of the diameter of the rim 4 and whose purpose is to counteract dynamic fluid induced torque, when the valve is more than 65 degrees open. Such torque reduction is needed when the fluid enters the side located opposite from the shaft.

In addition, vane 3 has an extended rim portion 13 located below the shaft. This extended rim portion, whose width H is typically 53% of the rim radius R. This extension serves as fluid impediment, in order to reduce dynamic torque, whenever the fluid enters from the side where the shaft is located.

FIG. 2 shows an alternate metal-seating arrangement, suitable for high temperature fluids where plastic is not suitable. Here the rim 4, when in the closed-valve position, presses against a deformable metal seal 9, typically made from stainless steel, having a thickened rim 9a pressed against shoulder 8 by a ring shaped nut 12.

Metal seal 9 extends nearly parallel to the curvature of rim radius R, but has itself a smaller, opposite curved, radius, so that only a part of the seal contacts the rim. This will avoid scraping contact of the terminating end of seal 9 against the rim surface 4.

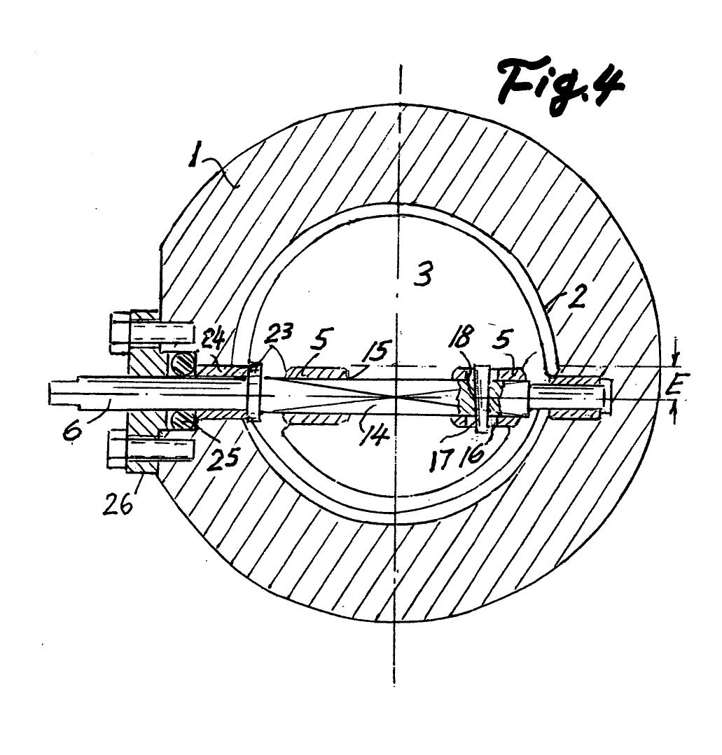

FIG. 3, shows yet another, simplified retention of deformable seal 20, where ring shaped nut 12 has a groove 20 to partially retain seal 7.

FIG. 4, finally shows the invention in a cross-sectional, horizontal view in order to clarify the features. Here we see that shaft 6 has a cylindrical extension supported in housing 1 by a bushing 24 and sealed by a packing 25, suitably retained by a flange 26.

Shaft 6 furthermore has an enlarged rim portion 23, supported by a shoulder of bushing 24 in order to absorb forces created by fluid pressure against the cross-sectional area of the shaft. As shown, vane 3 has two separate hub portions 5 having square openings to pass the square section 14 of the shaft.

Shaft portion 14, features a cross hole 16 containing a pin 17. Pin 17 passes freely through a larger passage 16 in one of the hubs 5, having ample clearance 18 on both sides, in order to compensate against misalignment. This arrangement has the purpose of guarding against the case where flange 26 may be removed accidentally, causing shaft 6 to be propelled out of the valve and cause harm. In such occasion, pin 17 will be retained by the walls of hole 16 and therefore keep shaft 6 from being expelled.

Having shown the invention in a preferred embodiment should nevertheless allow numerous modifications, without departing from the scope of the following claims. For example, it is quite possible to use a multi-splined shaft profile instead of a squared profile. Furthermore, a flanged seat ring retainer could be used instead of the preferred threaded retainer.

1. A double eccentric butterfly valve comprising a housing 1 having a central bore 2 capable of being connected to pipelines, a tillable vane 3 located within said central bore and having a continuously spherical shaped outer rim 4, said vane furthermore having one or more hub portions 5 capable of receiving a valve shaft 6 penetrating said housing perpendicularly to the center of said bore and being vertically off-set from said center, the spherical rim is capable to sealingly contacting a deformable seat ring suitably retained at one end of said bore, and wherein one half of the spherical rim is capable of interacting with the inner wall of the cylindrical bore in order to achieve a desirable flow characteristic.

2. A double eccentric butterfly valve as in claim 1, wherein said housing bore has a threaded end section 11 retaining therein a ring shaped nut 12 capable of retaining said seat ring.

3. A double eccentric butterfly valve as in claim 1, wherein said housing bore has a stepped shoulder 8 engaging a thickened rim 9a being part of said seat ring and being retained by said threaded nut 12, said seat ring furthermore has a thin, curved and flexible extension 9 having an inner and an outer diameter, and where the spherical rim 4 engages the inner diameter, whereas the outer diameter is slightly smaller than that of the ring shaped nut thereby allowing for eccentric displacement of the seat ring in order to align more perfectly with the spherical rim and thus can affect a tight shut-off against fluid pressure.

4. A double eccentric butterfly valve as in claim 2, wherein said housing bore has a threaded end section 11 retaining therein a ring shaped nut 12 capable of retaining said seat ring.

5. A double eccentric butterfly valve as in claim 1, wherein the center of said shaft is offset from the center where the spherical rim is contacting said seat ring.

6. A double eccentric butterfly valve as in claim 1, wherein the width of the spherical rim located closest to the shaft center is elongated 13 compared to the opposite rim in order to counteract dynamic fluid forces entering said housing from the side retaining the shaft.

7. A double eccentric butterfly valve as in claim 1, wherein said vane encompasses two separate hub portions 5 having a common bore 15 slidingly engaging said shaft 6.

8. A double eccentric butterfly valve as in claim 7, wherein said valve shaft has square cross section 14 engaging a similar opening in said two hubs thereby being capable of rotating the vane.

9. A double eccentric butterfly valve as in claim 7, wherein said shaft has a cross bore 16 enclosing a pin 17, said pin is fastened to said shaft and passing through one of said hubs through the enlarged bore 16 which is sufficiently large to prevent said shaft from being expelled from the vane yet allowing for some side movement of said vane to compensate for some misalignment caused by thermal expansion.

10. A double eccentric butterfly valve as in claim 1, wherein the lower periphery of said rim 26 extends above the planar surface of the vane located at the opposite side of said shaft to form a recess 19 in order to counteract dynamic torque when fluid passes from the side where the seat ring is located.

11. A double eccentric butterfly valve as in claim 9, wherein the overall width H of the lower portion of said rim 26 extends a distance H equivalent to 53% of the size of the spherical radius of said outer rim 4.

12. A double eccentric butterfly valve as in claim 1, wherein said d deformable seat ring encompasses a soft insert such as an O-ring 7 held by a retaining ring 7a located between said stepped shoulder and a ring shaped nut 12.

13. A double eccentric butterfly valve as in claim 11, wherein said deformable seat ring is made from PTFE (Teflon).

14. A double eccentric butterfly valve as in claim 1, wherein said shaft has an enlarged rim portion 23 supported by a guide bushing 24 and a suitable packing arrangement 25 capable of absorbing any hydrostatic pressure acting on the cross-sectional area of said shaft.
